(19) United States
(12) Patent Application Publication
(10) Pub. No.: US 2019/0266594 A1
(43) Pub. Date: Aug. 29, 2019

(54) REDUCING FRAUDULENT DATA TRANSFERS

(71) Applicant: MASTERCARD INTERNATIONAL INCORPORATED, Purchase, NY (US)

(72) Inventor: Muhammad Yaseen Ali, Dublin (IE)

(21) Appl. No.: 16/285,759

(22) Filed: Feb. 26, 2019

(30) Foreign Application Priority Data
Feb. 27, 2018 (EP) 18159017.5

(51) Int. Cl. G06Q 20/32; H04L 29/06

(52) U.S. Cl. CPC G06Q 20/3278; H04L 63/18; G06Q 20/3227

(57) ABSTRACT

A method to be performed in a mobile device is provided for altering security settings in relation to a data transfer. A near field communication, NFC, reader of the mobile device is used to detect the presence of a payment instrument in the vicinity of the mobile device. The payment instrument comprises a NFC readable element having identifying data thereon. On detecting the presence of the payment instrument, a first digital message is provided to a server of a data transfer system. The digital message instructs the data transfer system to alter security settings relating to a data transfer associated with the identifying data from a first security mode to a second security mode.

### CROSS-REFERENCE TO RELATED APPLICATION

This application claims the benefit of and priority to European Patent Application No. 18159017.5 filed Feb. 27, 2018. The entire disclosure of the above application is incorporated herein by reference.

### FIELD

The present disclosure generally relates to a method, apparatus and system for reducing fraudulent data transfers.

### BACKGROUND

This section provides background information related to the present disclosure which is not necessarily prior art.

Many data transfer systems, such as financial payment processors and digital communications servers, provide processes for preventing fraudulent transfers of data, such as unauthorized payments or the transfer of private information.

One such method of preventing fraudulent data transfers is for the data transfer system to require specified authorization credentials from a sender in order to verify that the sender is indeed authorized to make the transfer. In addition to the requirement of authorization credentials, the data transfer system may also make a further assessment of the risk of processing the data transfer and may reject the data transfer if it is decided that the transfer has a sufficiently high probability of the data transfer being fraudulent.

A problem in such processes is that many legitimate data transfers are incorrectly rejected due to their being considered potentially fraudulent. Conversely, fraudulent transfers may also be processed when not correctly identified as fraudulent by the processing system.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a method, performed in a mobile device, for altering security settings in relation to a data transfer, the method comprising: detecting, using a near field communication, NFC, reader of the mobile device, the presence of a control instrument in the vicinity of the mobile device, the control instrument comprising a NFC readable element having identifying data thereon, and on detecting the presence of the control instrument, providing a first digital message to a server of a data transfer system, the digital message instructing the data transfer system to alter security settings relating to a data transfer associated with the identifying data from a first security mode to a second security mode.

The above method allows the user to easily and instantaneously adjust security settings associated with a control instrument. Security settings may be lowered for a high mode immediately before a legitimate transfer in order to prevent a false rejection of a data transfer. Security settings may be set to a high level when the card is not in use to avoid unauthorized data transfers.

In some examples, the first digital message instructs the data transfer system to return to the first security mode when a predetermined period of time has elapsed after enabling the second mode.

In some examples, the method further comprises: subsequent to sending the first digital message to the server of the data transfer system: detecting, using the NFC reader of the mobile device, the presence of the control instrument in the vicinity of the mobile device, and on detecting the presence of the control instrument, providing a first digital message to a server of a data transfer system, the digital message instructing the data transfer system to alter security settings relating to a data transfer associated with the identifying data from a first security mode to a second security mode.

In some examples, the first security mode is a normal security mode and the second security mode is a high security mode.

In some examples, the first security mode is a high security mode and the second security mode is a normal security mode.

In some examples, prior to detecting the control instrument using the NFC reader of the mobile device, the security mode in relation to data transfers associated with the identifying data was changed from a normal security mode to a high security mode as a result of the data transfer system determining that a predetermined condition had been met.

In some examples, the predetermined condition is a data transfer determined by the data transfer system to have a high probability of being fraudulent.

In some examples, the high security mode requires that the data transfer system blocks data transfers in which the sender is identified by the secure identifying data.

In some examples, the high security mode requires that the data transfer system blocks data transfers that were not initiated using the control instrument.

In some examples, the normal security mode requires that the data transfer was initiated using the control instrument or using the secure identifying data.

In some examples, the control instrument is a control card.

In a second aspect, a mobile device is provided, the mobile device comprising a NFC reader and a communication node, the mobile device configured to perform the step of: detecting, using the NFC reader of the mobile device, the presence of a control instrument in the vicinity of the mobile device, the control instrument comprising a NFC readable element having identifying data thereon, and on detecting the presence of the control instrument, providing, using the communication node of the mobile device, a first digital message to a server of a data transfer system, the digital message instructing the data transfer system to alter security settings relating to a data transfer associated with the identifying data from a first security mode to a second security mode.

In another aspect, a system is provided, the system comprising: the mobile device of the second aspect being configured to perform the steps of the methods of the first aspect; a server of the data transfer system; and the control instrument.

In some examples of the above aspects, the control instrument is a payment instrument.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Aspects of the present disclosure will now be described by way of example with reference to the accompanying figures. In the figures:

FIG. 1 shows a system for performing data transfers in accordance with examples of the disclosure.

FIG. 2 is a flow diagram showing steps performed in an example of the disclosure.

Corresponding reference numerals indicate corresponding parts throughout the several views of the drawings.

### DETAILED DESCRIPTION

The following description is presented to enable any person skilled in the art to make and use the system, and is provided in the context of a particular application. Various modifications to the disclosed embodiments will be readily apparent to those skilled in the art. Embodiments will be described, by way of example only, with reference to the drawings. The description and specific examples included herein are intended for purposes of illustration only and are not intended to limit the scope of the present disclosure.

The present disclosure relates to a method, apparatus and system that allows a user to alter the security level applied to data transfers using their credentials. In particular, a user taps a control instrument onto a mobile device in order to activate and deactivate security features when needed by the user.

The embodiments described in detail below are provided in relation to the processing of payments. Accordingly, in the below examples, the control instrument used during the data transfers is a payment instrument, such as a debit card or credit card. However, it will be understood by the skilled person that the method described herein may be used in relation to other data transfer systems, and that in such systems the control instrument may be another suitable instrument for controlling security settings relating to a data transfer and/or initiating a data transfer.

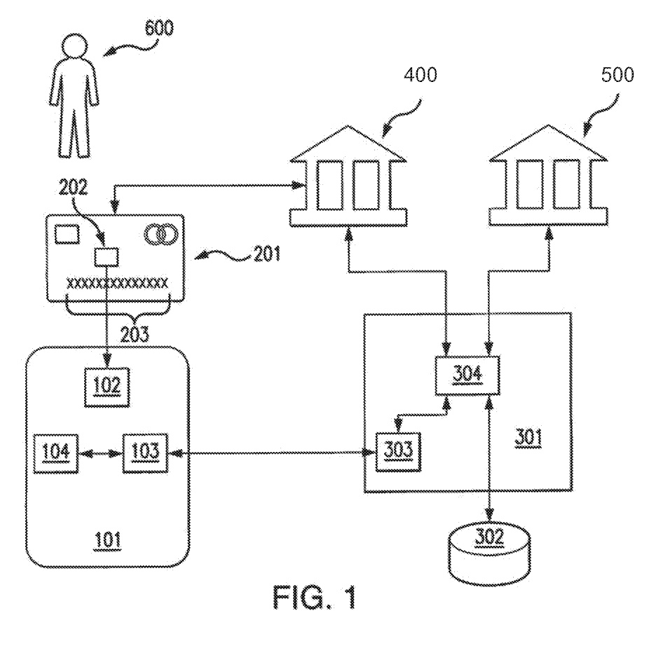

FIG. 1 shows elements in a system for use in the present disclosure. The system comprises a payment processor server 301 that is configured to process digital messages received from servers financial institutions 400; 500.

When a user 600 intends to make a payment to an account at an acquiring financial institution 500, a server at an issuing financial institution 400 generates an authorization request message (in accordance with a financial messaging standard, such as ISO 8583), which is sent to the payment processor server 301 to be forwarded on to the acquiring institution 500. The authorization request message comprises data indicating payment credentials 203 of the user, where the payment credentials 203 are associated with a payment instrument, such as a debit or credit card 201. The authorization request message further comprises various other data elements indicating further details of the transaction, such as the amount of the transaction and the recipient of the transaction.

Before forwarding the authorization request message to the acquiring institution 500, the payment processing server 301 performs checks to determine whether the authorization may be fraudulent. The checks may include verifying that the information in the data provided in the authorization request message matches records kept by the payment processer, such as an address of a user or a card security code.

The particular checks performed by the payment processing server 301 before deciding whether to process an authorization request message depend on the particular payment credentials used in the transaction. The payment processing server 301 has access to a security control database 302 that indicates the particular checks to be applied to a given transaction. When the payment processing server 301 receives an authorization request message, the payment processing server 301 may access the security control database 302 to first determine which checks are appropriate for the transaction before performing the checks. The security control database 302 may, for example, comprise a number of data entries, each of which defines the appropriate checks to perform on transactions originating from a given user. The particular user may be identified in the security control database 302 by elements of their payment credentials, such as their primary account number (PAN).

The security control database 302 defines at least two security modes for each user. In a normal security mode, the payment processing server performs checks that are normally performed during a payment data transfer, such as address and card security number verification processes. In a high security mode, the payment processing server may perform stricter security checks, such as blocking transactions where the transaction was initiated without the user's being in the vicinity of the merchant (cardholder not present transactions), or may block transactions from the user entirely. The normal security mode can be considered as a card “awake” mode, as the card may be used normally. Where transactions are blocked entirely, the high security mode can be considered as a card “sleep” mode, as the card is effectively disabled. A high security mode in which only certain classes of transfer (such as card not present transfers) are blocked can be considered as a “partial sleep” mode, as the card is disabled for certain classes of transfers but may be used for other transfers.

The security control database 302 may be updated in order to vary the specifications of the security checks that are applied to transactions originating from a given user. The payment processing sever 301 itself may specify certain aspects of the security checks, while the user may specify other aspects of the security checks himself. For example, the user may specify that in the high security mode a) no transactions are permitted, or b) that no card not present transactions are permitted.

In order to update the security control database 302, the user may interact with the payment processing server 301 via a dedicated application. A server side application 304 communicates with a client side application 104 installed on a computing device of the user. The computing device may be a mobile device 101 of the user or a desktop computer or another such device.

The user 600 may register its payment credentials using the application. The application retrieves different device related and also card related details from the device in use. The data is saved at the security control database 302 and may be used to identify the user and the user's devices 101. The user 600 can use the application 104 to configure the security settings stored in the security control database 302. For example, the user 600 may configure his security settings such that the high security setting prevents for all card not present transactions and ATMs, while only normal security checks are used in transactions that take place at a merchant premise. Additional security controls may also be applied to the normal security mode, though the remainder of the detailed description will assume that the normal security mode applies only to standard security controls to transactions.

A mobile device 101 of the user 600 has the above described application 104 stored in its memory. The mobile device 101 may be the same computing device used to set the security controls associated with the user 600 in the security control database 302. Alternatively, it may be a separate device having the application 104 stored thereon and having logged in with the same log in credentials.

The mobile device 101 comprises a near field communication (NFC) reader 102 and a communication node 103 configured to communicate (directly or indirectly) with a communication node 303 of the payment processing server 301. The NFC reader 102 is suitable for detecting the presence of a payment instrument 201 (such as a debit or credit card) associated with a payment account of the user 600 at an issuing financial institution 400. The payment instrument comprises a NFC readable identification tag 202 that comprises identifying data of the payment instrument 201. The identifying data may, for example, comprise the PAN of a credit or debit card.

The mobile device 101 is configured such that upon identifying the presence of the payment instrument having payment credentials registered to the application 104, the mobile device 101 sends a message to the payment processing server 301 (either directly or indirectly from communication node 103 to communication node 303) instructing the payment processing server 301 to switch from using (with respect to payments initiated using payment credentials of the user) either the high security controls to the normal security controls or from the normal security controls to the high security controls. Thus, by tapping the payment instrument 201 on the mobile device 101, the user 600 is able to change the security controls on payments using payment credentials 203 of the payment instrument 201. This allows the user 600 to effectively “wake” or put to “sleep” the payment credentials 203 associated with the payment instrument 201. Rather than a simple tap, other activation requirements may be chosen, such as a “tap and hold”, which requires that the payment card 201 is detected by the NFC reader 102 of the mobile device 101 for a minimum time period, for example 500 ms.

The user 600 may use the application 104 to specify the effect of tapping the card on the phone with respect to the security settings. The following examples provide examples of possible configurations of security settings and tap functionality that could be specified by a user. The skilled person will understand that features from the different examples can be combined or modified as desired within the scope of the present disclosure.

### EXAMPLE 1

The user 600 decides to configure the security settings relating to a payment card 201 in the security control database 302 such that the default security setting is a high security setting that rejects all transactions associated with the payment credentials 203. The payment card 201 is, therefore, in a “sleep” mode. The security settings are further configured such that tapping the payment card 201 to the mobile device 101 causes the mobile device 101 to send a message to the payment processing server 301 resulting in the security mode changing to a normal security mode. The user 600 has further specified that the security mode remains in the normal security mode for fifteen minutes time before the security setting automatically returns to the high security mode. Thus, the payment card is “woken” for a fifteen minute time period by tapping the payment card on the mobile device 101. The security settings may be further configured such that the payment card automatically “sleeps” (i.e., returns to the high security mode) after a payment has been made using the payment credentials 203.

An illustration of a use of this example is as follows. The user 600 goes to a merchant store to obtain goods. At the time of payment, the user 600 taps the payment card 201 to his mobile device 101. The mobile device 101 detects the presence of the NFC tag 202 of the payment card 201 and sends a message to the payment processing server 301 to change security settings for the payment credentials 203 from a high setting to a normal setting for fifteen minutes. The payment card 201 “wakes up” for fifteen minutes, in which time the user 600 pays for goods from the merchant using an authorization request message which is processed by the payment processing server 301 according to the normal security controls. After the purchase, the payment card 201 automatically goes back to “sleep” after fifteen minutes when the payment processing server 301 changes the security settings from the normal security mode to the high security mode.

If the user 600 subsequently loses the payment card 201, or if a malicious party steals and uses the payment credentials 203, the payment card 201 cannot be used to make payments as the payment card 201 will be in a “sleep” mode.

### EXAMPLE 2

The user 600 specifies that in the high security mode, the card “partially sleeps”, such that card not present transactions are blocked, whereas cardholder present transactions are allowed. The user 600 further specifies that a first tap of payment card 201 on the mobile device 101 causes the security settings to change from the high security mode to a normal security mode. A second tap of the payment card 201 on the mobile device 101 causes the security settings to change from the normal security mode to the high security mode. There may or may not be a predetermined time limit after which the security settings return from the normal security mode to the high security mode.

The user 600 is able to purchase goods in shops and use ATMs in the high security mode. When the user 600 wishes to make a card not present payment, such as a payment transaction in which the payment credentials 203 associated with the payment card 201 are provided over the telephone, the user 600 taps the payment card 201 on the mobile device 101. The mobile device 101 then sends a message to the payment processing server 301 causing the security settings to change to the normal security mode. The user 600 then makes a telephone payment while the payment card 201 is in the normal security mode and, subsequently, taps the payment card 201 to the mobile device 101 again to restore the high security mode.

### EXAMPLE 3

The user 600 specifies that the mobile device 101 is in a normal security mode by default. The security settings are configured such that the security mode is automatically changed by the payment processing server 301 to a high security mode on detection of an event fulfilling a predetermined alert condition indicating that activity may be fraudulent. The predetermined alert condition may be, for example, authorization requests for amounts of more than $500USD made in quick succession in a certain shop in a certain country. The high security mode blocks all transactions made using the payment credentials 203. Thus, the card may automatically enter a “sleep” mode when a fraudulent payment is suspected.

The security settings specify that tapping the payment card 201 to the mobile device 101 causes the payment credentials 203 to be returned to the normal security level.

This process allows false declines of cards to be avoided when fraud is incorrectly suspected by the payment processing server 301. Instead of declining the payment card 201, the payment card 201 is put into “sleep” mode when a fraud is suspected. The user 600 may discover that the payment card 201 is in a “sleep” mode at a subsequent use (at an ATM, for example) without having been explicitly requested to enter said mode. The user may determine that the sleeping of the card is an anti-fraud measure that user specified in the security settings. The user 600 may then hold the payment card 201 to the NFC enabled mobile device 101 to reactivate the card.

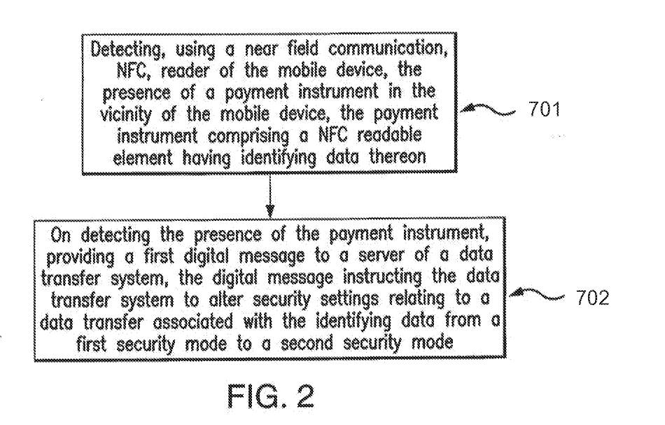

FIG. 2 shows a flow diagram illustrating the steps performed by a mobile device 101 in an example of this disclosure.

In step 701, the mobile device 101 detects, using a NFC, the presence of the payment instrument 201 in the vicinity of the mobile device 101. The payment instrument 201 comprises a NFC readable element 202 having identifying data thereon. Step 701 occurs when a user taps a payment instrument (such as a payment card 201) registered with the security control application 104; 304 against a mobile device 101 having a NFC reader and the security control application 104 stored thereon. The identifying data may indicate payment credentials 203 associated with the payment card 201.

In step 702, the mobile device 101, on detecting the presence of the payment instrument 201, provides a first digital message to a server of a data transfer system. The digital message instructs the data transfer system to alter security settings relating to a data transfer associated with the identifying data from a first security mode to a second security mode.

The first security mode may be a high security mode and the second security mode may be a normal security mode. Alternatively, the first security mode may be a normal security mode and the second security mode may be a high security mode. Thus, by tapping the payment instrument 201 on the mobile device 101, a user may either cause the payment instrument 201 to “wake” or to “sleep” depending on the chosen security settings as configured by the user 600.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

Receivers and transmitters as described herein may be standalone or may be comprised in transceivers. User input devices can include, without limitation, microphones, buttons, keypads, touchscreens, touchpads, trackballs, joysticks and mice. User output devices can include, without limitation, speakers, graphical user interfaces, indicator lights and refreshable braille displays. User interface devices can comprise one or more user input devices, one or more user output devices, or both.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for altering security settings in relation to a data transfer, the method comprising:
detecting, by a mobile computing device, using a near field communication (NFC) reader of the mobile computing device, the presence of a control instrument in the vicinity of the mobile computing device, the control instrument comprising a NFC readable element having identifying data thereon; and
on detecting the presence of the control instrument, providing, by the mobile computing device, a first digital message to a server of a data transfer system, the digital message instructing the data transfer system to alter security settings relating to a data transfer associated with the identifying data from a first security mode to a second security mode.

2. The method of claim 1, wherein the first digital message instructs the data transfer system to return to the first security mode when a predetermined period of time has elapsed after enabling the second mode.

3. The method of claim 1, further comprising, subsequent to sending the first digital message to the server of the data transfer system:
detecting, using the NFC reader of the mobile computing device, the presence of the control instrument in the vicinity of the mobile computing device; and
on detecting the presence of the control instrument, providing the first digital message to the server of the data transfer system.

4. The method of claim 1, wherein the first security mode is a normal security mode and the second security mode is a high security mode.

5. The method of claim 1, wherein the first security mode is a high security mode and the second security mode is a normal security mode.

6. The method of claim 5, further comprising, prior to detecting the control instrument using the NFC reader of the mobile computing device, changing the security mode in relation to data transfers associated with the identifying data from a normal security mode to a high security mode as a result of the data transfer system determining that a predetermined condition is met.

7. The method of claim 6, wherein the predetermined condition is a data transfer determined by the data transfer system to have a high probability of being fraudulent.

8. The method of claim 4, wherein the high security mode requires that the data transfer system block data transfers in which the sender is identified by the secure identifying data.

9. The method of claim 4, wherein the high security mode requires that the data transfer system block data transfers not initiated using the control instrument.

10. The method of claim 4, wherein the normal security mode requires that the data transfer be initiated using the control instrument or using the secure identifying data.

11. The method of claim 1, wherein the control instrument is a control card.

12. A mobile device comprising a near field communication (NFC) reader and a communication node, the mobile device configured to:
detect, using the NFC reader, the presence of a control instrument in the vicinity of the mobile device, the control instrument comprising a NFC readable element having identifying data thereon; and
on detecting the presence of the control instrument, provide, using the communication node, a first digital message to a server of a data transfer system, the digital message instructing the data transfer system to alter security settings relating to a data transfer associated with the identifying data from a first security mode to a second security mode.

13. A system comprising:
a mobile device;
a server associated with a data transfer system and in communication with the mobile device; and
a control instrument;
wherein the mobile device is configured to:
detect, using a near field communication (NFC) reader of the mobile device, the presence of the control instrument in the vicinity of the mobile device, the control instrument comprising a NFC readable element having identifying data thereon; and
in response to detection of the presence of the control instrument, provide, using a communication node of the mobile device, a first digital message to the server associated with the data transfer system, the digital message instructing the data transfer system to alter security settings relating to a data transfer associated with the identifying data from a first security mode to a second security mode.

14. The system of claim 13, wherein the control instrument is a payment instrument.

15. The method of claim 5, wherein the high security mode requires that the data transfer system block data transfers in which the sender is identified by the secure identifying data.

16. The method of claim 5, wherein the high security mode requires that the data transfer system block data transfers not initiated using the control instrument.

17. The method of claim 5, wherein the normal security mode requires that the data transfer be initiated using the control instrument or using the secure identifying data.

18. The method of claim 1, wherein the control instrument is a payment instrument.
